(19) United States
(12) Patent Application Publication
(10) Pub. No.: US 2019/0362358 A1
(43) Pub. Date: Nov. 28, 2019

(54) METHOD AND SYSTEM OF SECURE PAYMENT

(71) Applicant: GRE-LAB S.R.L. UNIPERSONALE, Padova (PD) (IT)

(72) Inventor: Mara VENDRAMIN, Padova (PD) (IT)

(73) Assignee: GRE-LAB S.R.L. UNIPERSONALE, Padova (PD) (IT)

(21) Appl. No.: 16/467,523

(22) PCT Filed: Dec. 18, 2017
(86) PCT No.: PCT/IB2017/058046

§ 371 Date: Jun. 7, 2019

(30) Foreign Application Priority Data
Dec. 16, 2016 (IT) 102016000127703

(51) Int. Cl. G06Q 20/40; G06Q 20/34

(52) U.S. Cl. CPC G06Q 20/40145; G06Q 20/4012; G06Q 20/351

(57) ABSTRACT

A management method and system of an electronic transaction between an account of a purchaser subject and an account of a seller subject is provided. The method and system allow buyers to not employ physical supports of money such as banknotes/coins, credit cards or phone devices and of carrying out payments in a dematerialized fashion. Security of payments is ensured by user's authentication, based on the recognition of at least a user's biometric parameter previously recorded in the system, by a PIN code, by the picture of the user's face and by an algorithm that identifies buying habits. An account is associated to the registered user, from which the amount to be given for the payment is debited.

### TECHNICAL FIELD OF THE INVENTION

The present invention relates to a method and to a system for managing an electronic transaction between an account of a buyer and an account of a seller.

The proposed method and system allow to not use physical money support such as banknotes/coins, credit cards or telephone/personal electronic devices and to make payments in a dematerialized mode in a completely secure fashion. The security protocol is based on the recognition of at least one biometric parameter of a user previously registered before the system, on a pin code, on a picture of the user's face and on the association of the identity of the recognized user to a registered account to that user, from which the amount to be paid is taken in order to make the payment.

### BACKGROUND

Presently, those who want to buy goods in stores must have cash or credit/debit cards with which to make payments. In other words, buyers must be provided with physical money support.

The fact of having to bring cards or cash or telephone devices exposes buyers to serious risks of being subjected to robbery or snatching by malicious people who want to steal money.

Furthermore, disadvantageously, cards and cash can be easily lost or damaged and become unusable due to the inherent perishable nature of the materials with which these supports are made.

The document US2015/0046328, on the basis of which the preamble of claim 1 is drafted, discloses a method for executing a computerized system to perform financial transactions based on the use of a user's fingerprint.

The document US2014/0330729 shows in a generic way the idea of executing financial transactions using a picture of the face of the user performing the transaction.

### SUMMARY OF THE INVENTION

The addressed technical problem solved by the present invention is thus that of providing a method and a system which allow to overcome the aforementioned drawbacks of the prior art.

This problem is solved by a method according to claim 1 and by a system according to claim 4.

Preferred features of the present invention are defined in the dependent claims.

The present invention provides a management method and a management system of transactions, which allow buyers to not employ physical support of money, such as banknotes or cards, in order to be recognized and to complete transactions.

The security of transactions is guaranteed thanks to the recognition of at least one user's bio-metric parameter, and preferably also of a pin code and of a picture of the same user previously recorded in the system of the invention, as well as on the association of the recognized user's identity to an account belonging to that user. The account may be either a dedicated account generated directly in the system of the invention or a pre-existing account from which the amount to be paid will be taken in order to make the payment. Once recognized by the system, the recognized user can select the account for the payment. To authorize the payment, the user may also enter an authorization code or pin.

Advantageously, the method according to the present invention allows registered users to perform personal recognition and transactions in total security conditions.

Thanks to the present invention, the buyers are disconnected from annoying debit cards that may be demagnetized, cash that may be snatched, credit cards that may be easily cloned.

Furthermore, the use of user's biometric parameters for the necessary recognition for authorizing payments makes the identification certain and, as a matter of fact, does not allow third parties to make undue payments from user's account. Fingerprints are not easy to clone, and even if they were cloned, the user's picture, associated with the fingerprint in the system's memory, allows the seller to verify user's identity in real time. The insertion of a pin, which can be memorized by the user at the time of registration, represents a further security feature.

This implies an increase of safety of buyers and a greater simplicity of payments by electronic transactions and, more in general, an improvement of the quality of life.

Other advantages, features and methods of use of the present invention will be clear from the following detailed description of several embodiments, disclosed as non-limiting examples.

### BRIEF DESCRIPTION OF THE FIGURES

Reference will be made to the attached Figures, in which:

FIGS. 1 and 2 schematically show a preferred embodiment of a system for implementing a dematerialized payment method according to the present invention;

FIG. 3 shows a preferred embodiment of a recording step of the method according to the present invention;

FIG. 4 shows a first preferred embodiment of a payment phase of the method according to the present invention;

FIG. 5 shows a second preferred embodiment of a payment authorization phase of the method according to the present invention; and

FIG. 6 is a flowchart of an algorithm, based on considerations of physiognomy and of genetic determinism, to verify further the identity of a user making a payment.

The above Figures are intended exclusively for illustrative and non-limiting purposes.

### DETAILED DESCRIPTION OF PREFERRED EMBODIMENTS

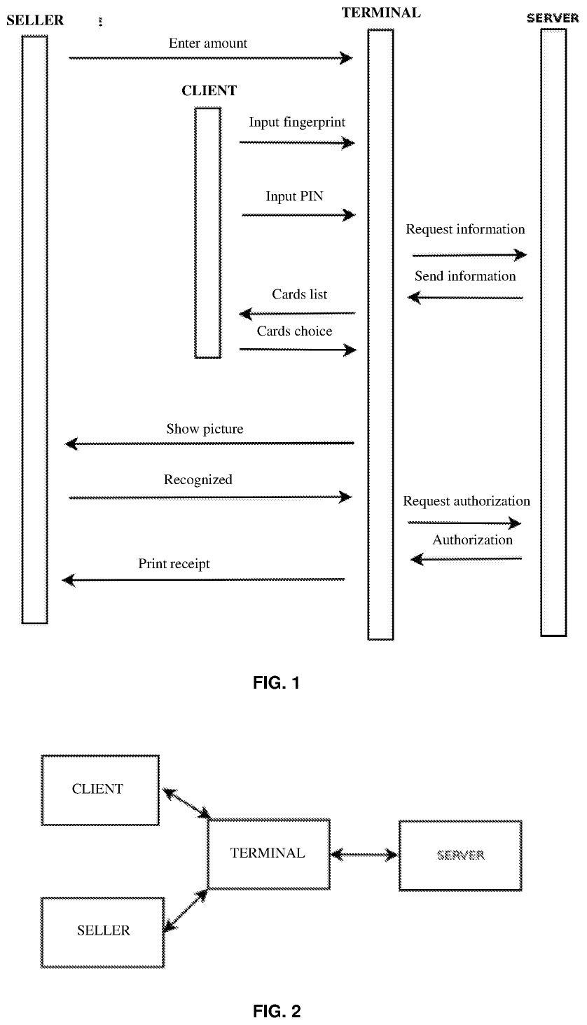

Referring to FIGS. 1 and 2, a preferred embodiment is shown of a management system of an electronic transaction according to the present invention, labeled as a whole with the reference numeral 1.

The system 1 relates to the field of application of electronic payment systems between buyers and sellers (or merchants) with an account. In the present discussion, the word “account” means a deposit of money similar to a bank account, which allows the transaction of electronic money.

System 1 first comprises a central unit or server 2 and one or more terminals or payment devices 3 connected to the central unit, remote from said central unit 2. Payment devices 3 may be located in commercial activities, for allowing users to pay items securely according to a dematerialized method, without needing a physical support of money.

In order to use the system of the invention, a user must be registered. User registration may be performed using electronic devices such as PCs, tablets and smartphones, connected to the server 2, for example via Internet, or provided with a dedicated Application.

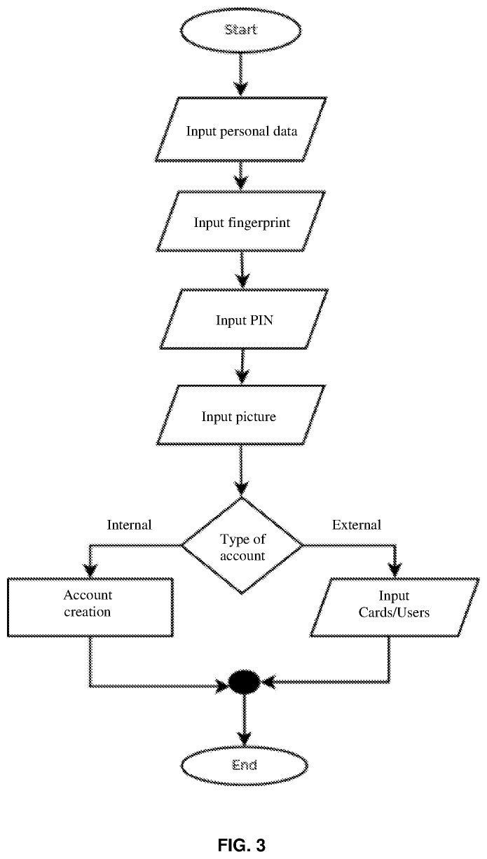

The registration phase (FIG. 3) requires the user to input the server 2, through suitably designed interface means, with some data that includes at least one biometric data—preferably a fingerprint—and data from at least one pre-existing account associated to the user. Furthermore, the system may allow the user to create a new virtual account. These data are stored in server 2 storage means suitably designed for this purpose.

Additional data that may be required to be entered and stored in server 2, so that they are associated with the user and are used to authenticate the user at the time of payment, are: personal data, a security code or PIN chosen by the user and a picture of the user's face so that it is possible to perform a facial recognition, as will be better described hereinbelow.

The personal details of the user may include name, surname/name, residence, tax code/VAT number and email address.

Moreover, during the registration phase it is possible to choose the following parameters related to the payment and to the use of the service:
language; and
type of currency.

As far as the insertion of biometric data and images of the user's face is concerned, the server 2 may include means for acquiring biometric data and images. In particular, such biometric data acquisition means comprises a user's fingerprint acquisition means, while the image acquisition means may comprise a video camera or a camera.

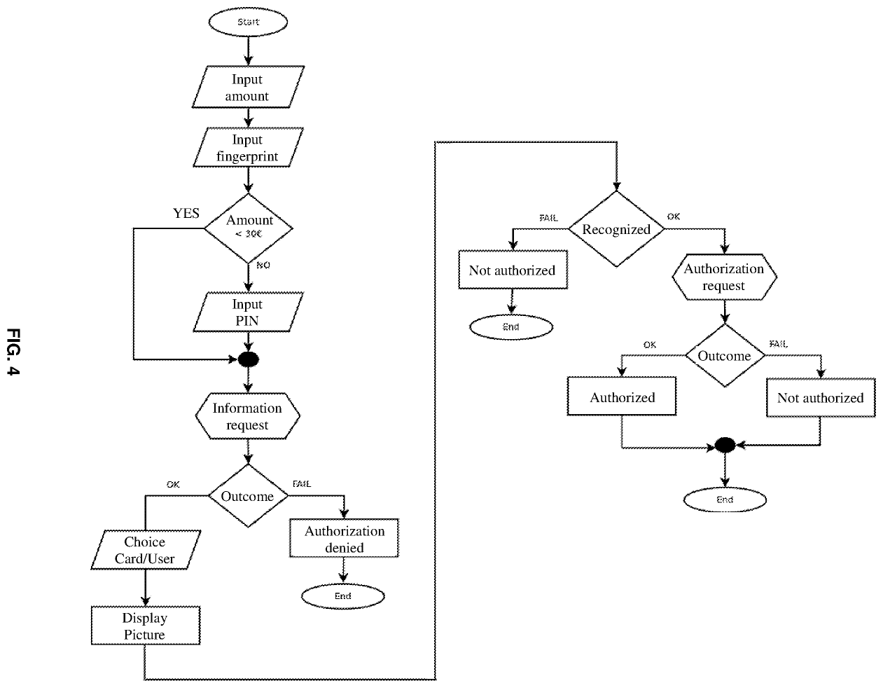

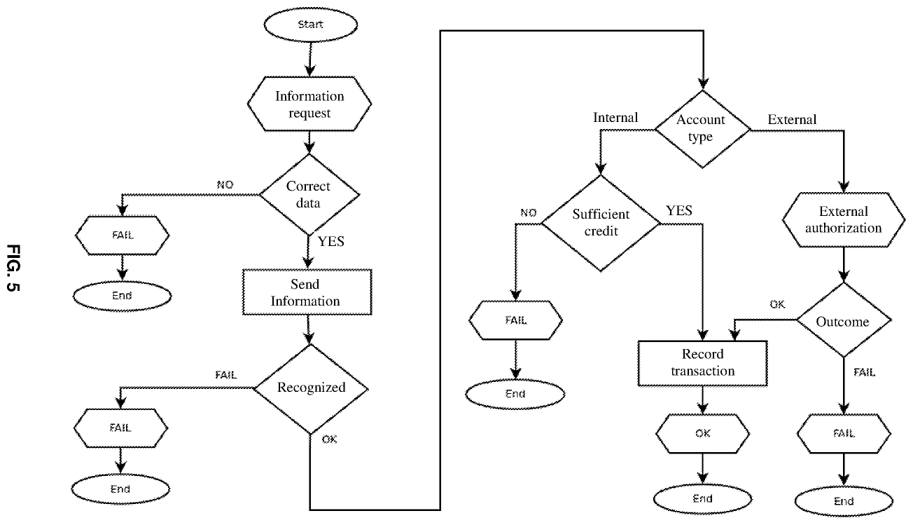

When the registered user has to make a payment through the system of the invention, he uses a payment device 3, which includes all the means necessary for the authentication of the user and for the authorization of the payment (FIGS. 4 and 5).

The payment device 3 comprises: acquisition means of biometric data, means for processing the acquired biometric data and interfacing and processing means configured for allowing the user to input data—such as the security code—and for their processing, as well as for allowing the choice of the account associated to the user from which to make the electronic transaction on the account of the seller. According to alternative embodiments of the invention, the payment device 3 comprises only data acquisition and interface means, while the data processing means are implemented on the server 2.

In order to make the payment, the user must first authenticate himself. The authentication of the registered user involves the acquisition of at least one biometric data of the user, for example the fingerprint, by the acquisition means of the payment device 3 and of the verification of the correspondence of the acquired biometric data with the biometric data stored in the server 2.

The system 1 thus associates the digital fingerprint of the buyer with the fingerprint of the user stored in server 2. As a further confirmation of the identity of the user, the seller can view the picture of the user's face stored in the server in association with the data entered by the buyer up to that moment, in order to verify exactly his/her identity. Furthermore, the user is also requested to enter the security code, which is compared to the stored code associated with the fingerprint, to confirm the purchase.

Preferred embodiments of the proposed method allow to verify the user's identity in a secure manner by means of the fingerprint, by means of the visual recognition by the seller and by means of the insertion of the security code created by the user himself.

Once the buyer is authenticated in the system 1, the payment device interface 3 allows the user to select the account for debiting the payment (if more than one account associated with the authenticated user is recorded). The user may also, if authorized during the initial registration phase, pay with a third party account, for example a child may be connected to the parent's account.

Once the user has chosen the account, the seller enters the amount to be paid using the interface of the device 3, or in any case the amount is automatically entered by scanning the purchased items.

As anticipated, in order to authorize the payment, the device 3 may request insertion of the security code or PIN of the user. If the entered code matches the security code stored in the server 2 in association with the authenticated user, the system authorizes the electronic transaction from the account of the buyer to the account of the seller.

According to preferred embodiments of the invention, the system 1 may be configured to automatically store information relating to purchases made by the user. Based on historical data of purchases, it may be realized an algorithm that calculates a compatibility value of the purchase to be made with previous purchases, while being in the process of authorizing a payment, to report any eventual anomaly.

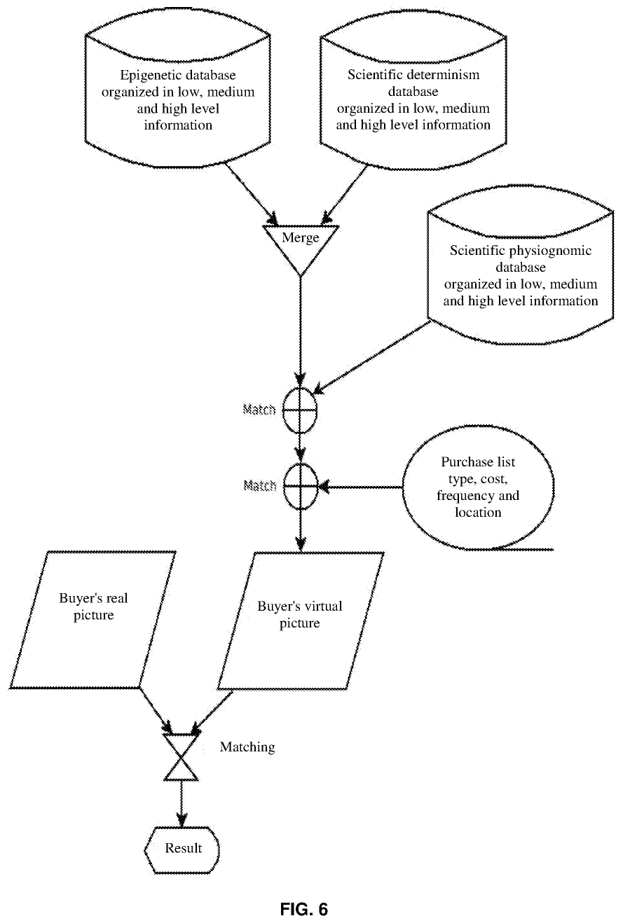

A basic scheme of such an algorithm is exemplified in FIG. 6.

The algorithm is essentially based on principles and theories of scientific physiognomy/genetic determinism/epigenetics, and provides the association of the registered customer to his spending habits (for example the historical data concerning the amount of the expense, the geographical place where the expenditure is carried out, etc.). The data relating to the customer's spending habits may be used in the recognition phase of the user when a payment is being carried out.

Basically, principles of these theories are combined to rebuild recognizable features of a user's face from the information obtained from his/her spending habits. By organizing the collected and stored data about spending habits, according to algorithms based on low, medium and high level information, it is possible to obtain other information that, put together, lead to a facial composite of the face of the person.

In other words, as in the artificial vision, each single information determines a “pixel” in the formation of the picture of the corresponding face. It could be contemplated the step of authorizing a payment only if the so reconstructed “virtual” picture substantially matches the true aspect of the user.

In other words, the system 1 may provide for the execution of a series of algorithms that will become more and more accurate and unequivocal as the customer uses the payment system, based on the user's habits, that is the type of payments made and the places where transactions are performed. In this way, as the number of performed transactions increases, the system develops a unique profile of the user, following his/her habits and the sites he/she frequents most, both as type of places as well as geographical positions. This profiling, combined with the fingerprint and the pin, makes the proposed payment system impossible to be cracked and duplicated.

The invention has been described with reference to preferred embodiments. It is to be understood that other embodiments may exist which use the same inventive core, as defined by the scope of protection of the claims set forth below.

1. A management method of an electronic transaction between an account of a purchaser subject and an account of a seller subject by means of a management system, said method comprising the steps of:
a) registration of the user, comprising storing a user biometric data, wherein said biometric data is a user's fingerprint, a security code associated with the user and data of an account associated with the user in storage means comprised in a central unit of said management system;
b) authentication of the registered user by means of a payment device connected to said central unit, said step of authentication comprising an acquisition of said user biometric data by means of acquisition means and a verification of the correspondence of said acquired biometric data with said stored biometric data;
c) choosing an account associated with the user on which charging the payment through memorized accounts associated with the user;
d) request for insertion of said security code to authorize payment; and
e) if the inserted code matches said stored security code, authorize the electronic transaction from the chosen account of the purchaser subject to the account of the seller subject;
wherein said step of user registration comprises the further steps of:
insertion of user's personal data and storage in said storage means; and
acquisition of an image of the user's face and storage in said storage means; and said management method comprises the step of displaying said image of the user's face stored and associated with said acquired biometric data before authorizing the transaction.

2. The method according to claim 1, comprising a step of verification of the compatibility of the transaction with transactions previously performed by the user, through the execution of algorithms that process data relating to the user's buying habits.

3. The method according to claim 1, comprising a step of storing user's buying habits and executing calculations of statistical correlation between said user's buying habits and one or more user's physiognomic characteristics.

4. A management system of an electronic transaction between an account of a purchaser subject and an account of a seller subject, apt to implement a step of the method according to claim 1, said system comprising:
a central unit comprising:
first interface means for the insertion of data associated with one or more users, said data being biometric data, security codes and data relating to accounts; and
storage means of said data;
one or more payment devices, remote with respect to said central unit, each payment device comprising second interface means configured for the insertion of data by a user and comprising acquisition means of biometric parameters of a user; and
connection means of said central unit to said one or more payment devices,
wherein said central unit further comprises data processing means, apt to compare the data inserted by the user by means of said second interface means with the stored data;
wherein said acquisition means of biometric parameters are configured for the acquisition of fingerprints;
and wherein said data associated with one or more users further comprise personal data and facial images.

5. The management system according to claim 4, wherein said central unit comprises acquisition means of biometric and image data.

6. The management system according to claim 4, wherein said storage means are configured to store data related to user's buying habits.

7. A computer program configured to implement a method of dematerialized payment according to claim 1 when executed on a computer.
